(19) United States
(12) Patent Application Publication
(10) Pub. No.: US 2007/0063471 A1
(43) Pub. Date: Mar. 22, 2007

(54) Glass handling systems

(75) Inventor: Ricardo Carlei, Victoria (AU)

Correspondence Address: HARNESS, DICKEY & PIERCE, P.L.C., P.O. BOX 828, BLOOMFIELD HILLS, MI, 48303, US

(73) Assignee: Quantum Workhealth Programmes Pty Ltd., Essendon, Victoria (AU)

(21) Appl. No.: 10/563,718

(22) PCT Filed: Jul. 9, 2003
(86) PCT No.: PCT/AU03/00882

§ 371 Date: Apr. 26, 2006

(51) Int. Cl. B62B 1/00

(52) U.S. Cl. 280/79.7

(57) ABSTRACT

A device for handling glass or other sheet material is in the form of a wheeled trolley capable of manual manipulation and having a support shaft which extends upright in use of the trolley. Two or more vacuum grips are mounted on the shaft for movement into selected positions along the shaft.

The present invention relates to systems for handling sheets of glass or other sheets of relatively rigid and relatively smooth material such as metal, marble, or plasterboard.

To manually manoeuvre relatively large sheets of glass or metal, a grip device may be temporarily applied to the surface of the sheet to provide a hand grip or hand hold by which the sheet can be held. U.S. Pat. No. 3,240,525 discloses a vacuum grip having a handle and a gripping pad which can be attached to the surface of the sheet by a small hand-operated vacuum pump whereby the grip can be securely attached to the surface of the sheet by a vacuum effect without damaging the surface of the sheet. Vacuum grips of the type shown in U.S. Pat. No. 3,240,525 have been commercially available for many years and are in common use to facilitate manual transportation and maneuvering of relatively large sheets of glass and the like in factories, in workshops, and by trades people such as glaziers and shop fitters. Typically, for use with larger sheets of glass, two or perhaps more, of the vacuum grips are applied to the surface of the sheet to enable the sheet to be maneuvered and transported by two or more people, and when the sheet is in the required position the grips are removed from the sheet simply by releasing the vacuum.

Although grips such as those just described are a significant aid to handling large sheets of glass and the like, nevertheless due to the weight of the glass sheet and sometimes the physical size of the sheet, strain injuries can often arise to personnel. A particular problem can also arise when manipulating a large sheet of glass for accurate placement into a frame such as may be incorporated in a shop front or similar.

According to the present invention, there is provided a device for handling glass or other sheet material, said device being in the form of a wheeled trolley and having at least one vacuum grip for releasable attachment to the surface of the sheet to thereby support the sheet from the trolley, said trolley having at least one ground engaging wheel, and means enabling the height of the vacuum grip relative to the wheel to be adjusted.

Further according to the invention, there is provided a device for handling glass or other sheet material, said device being in the form of a wheeled trolley capable of manual manipulation and having a support shaft which extends upright in use of the trolley, two or more vacuum grips mounted on the shaft for movement into selected positions along the shaft, and means for supporting at least one of the grips in a selected position along the shaft.

Still further according to the invention, there is provided a device for handling glass or other sheet material, said device being in the form of a wheeled trolley capable of manual manipulation and having at least one vacuum grip for releasable attachment to the surface of the sheet to thereby support the sheet from the trolley, the trolley having at least one ground-engaging wheel.

In one preferred form, the vacuum grip comprises a vacuum gripping pad associated with a vacuum pump which can be operated to apply a vacuum.

In preferred embodiments of the invention, the trolley comprises a main support shaft which extends upright in use of the trolley and the vacuum grip is mounted for movement into a selected position along the length of the shaft with means to secure the grip in a selected position.

In one embodiment, the shaft is threaded and the vacuum grip includes threaded structure for engagement with the thread of the shaft. Preferably the threaded structure is in the form of a split nut which can be released from engagement with the shaft thread to thereby enable the vacuum grip to be displaced along the shaft to a selected position at which the split nut is re-engaged. This embodiment may also include means for rotating the shaft whereby when the threaded structure is engaged with the shaft and the vacuum grip is coupled to the sheet, rotation of the shaft will raise or lower the sheet relative to the ground to thereby permit relatively fine adjustment in the height of the sheet to facilitate placement.

In another embodiment, the grip is secured in a selected position by a pin inserted through the body of the grip to engage in a selected one of a series of holes spaced lengthwise in the shaft.

In yet another embodiment, the grip is held in a selected position along the shaft by means, such as a winch cable or gas spring, which permits controlled lowering of the grip.

In yet another embodiment, the trolley may include a gas spring which supports the shaft from the wheel or wheels to permit controlled lowering of the sheet carried by the trolley.

A system for handling relatively large sheets will involve the use of at least two trolleys as defined above. For this purpose it is preferred for each trolley to have tandem mounted ground-engaging wheels at the lower end of the main supporting shaft, the wheels being mounted with a caster action and being spaced in a fore-aft direction to provide a stable support not liable to tip.

In alternative forms, the trolley may have wheels spaced in a direction lengthwise of the sheet so that use of a single trolley with smaller sheets will itself provide stable support.

Embodiments of the invention will now be described by way of example with reference to the accompanying drawings in which:

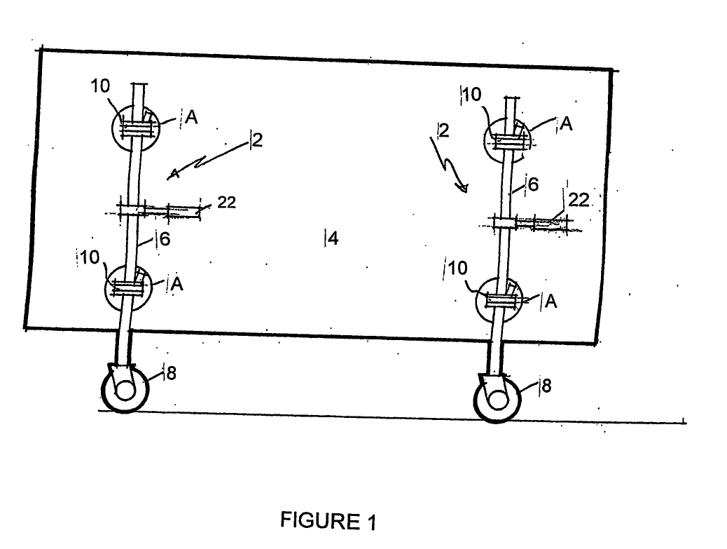

FIG. 1 is a schematic view showing a sheet handling system involving the use of two wheeled trolleys in accordance with one embodiment of the invention;

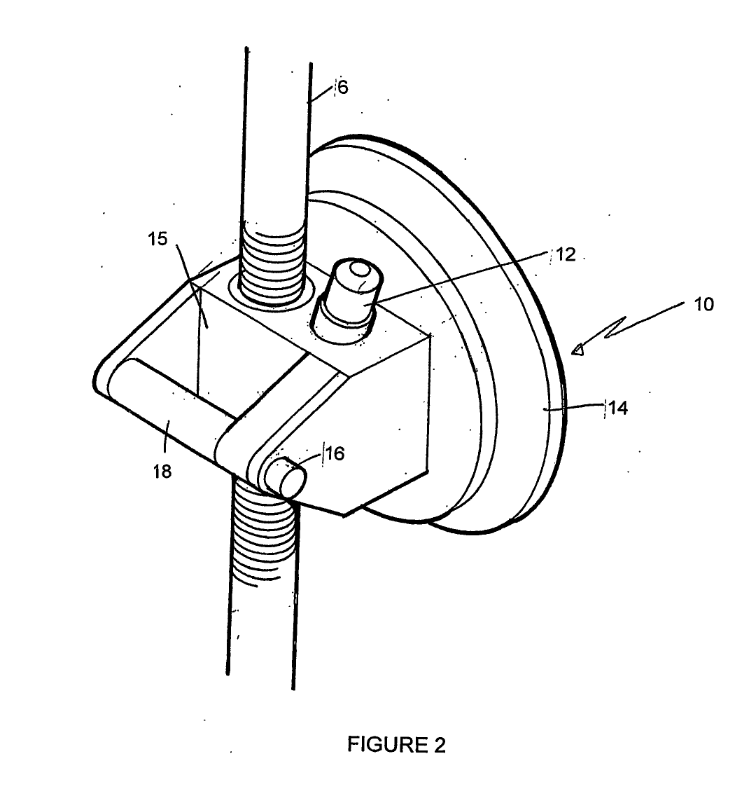

FIG. 2 shows schematically a detail “A” of the trolleys of FIG. 1 to show a vacuum grip and its relationship with a main support shaft;

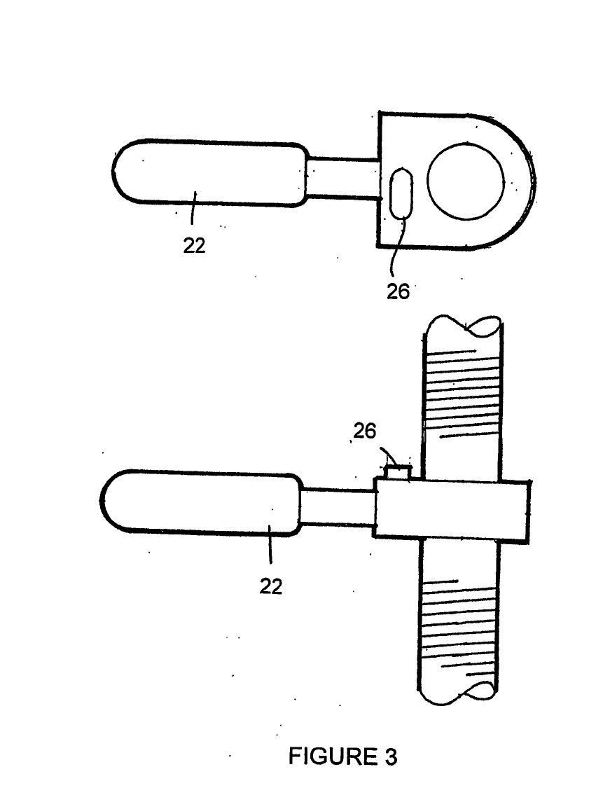

FIG. 3 is a fragmentary view showing an actuating handle and associated structure of a ratchet system for rotating the main support shaft;

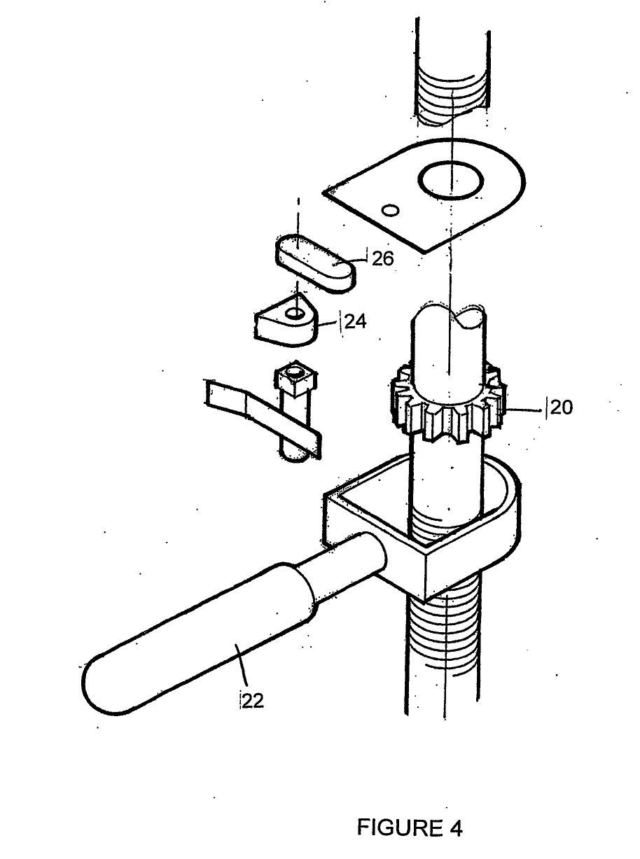

FIG. 4 is an exploded view corresponding to FIG. 3; and

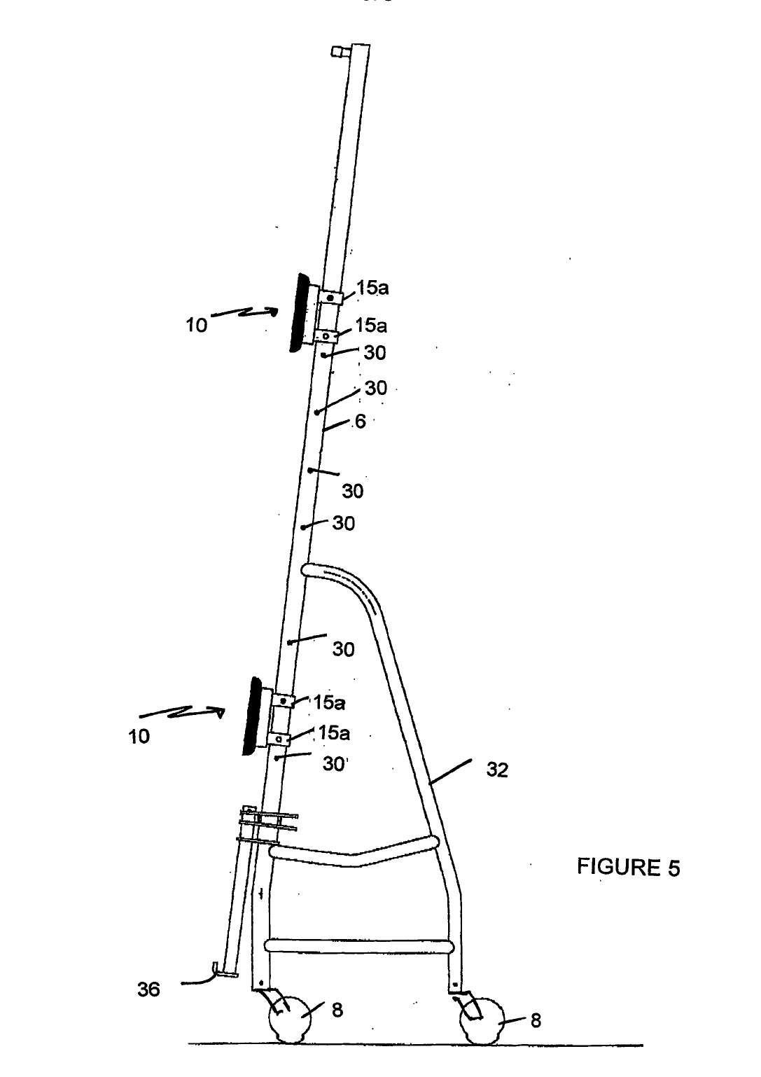

FIG. 5 is a side view showing an alternative embodiment of the invention.

FIG. 1 of the drawings shows a glass handling system in accordance with one embodiment of the invention. The handling system comprises two wheeled trolleys 2 to which a sheet 4 of glass is attached so that the sheet can easily be transported and manually maneuvered. Effectively therefore the sheet 4 can be wheeled along the ground without causing undue strain to the personnel concerned. Each of the trolleys 2 is identical and the construction of the trolley will now be described.

The trolley 2 consists of a single support shaft 6 which is upright during use. The lower end of the shaft 6 carries a single wheel 8 which is preferably supported from the shaft with a caster action. In alternative arrangements, the trolley 2 can have more than one wheel at the lower end of the support shaft 6, for example two wheels arranged side by side or in tandem. The support shaft 6 carries two vacuum grips 10 at upper and lower positions along its length to permit secure, but releasable, attachment to the sheet 4. It is to be noted that although the embodiment illustrated has the two vacuum grips 10, the invention is not restricted to the use of two grips; depending on particular requirements, the trolley may be designed with only a single vacuum grip or more than two vacuum grips. The basic construction and operation of the vacuum grip 10 including a vacuum pump 12 with a vacuum release facility is preferably as disclosed in U.S. Pat. No. 3,240,525 to which reference may be made particularly for an understanding of preferred aspects of the design of a gripping pad 14 and associated structure. The vacuum grip 10 used in this embodiment of the invention differs from that shown in the US patent principally in the design of its main body by which it is attached to the support shaft 6 and that will now be described in detail.

As shown, the main body 15 of the grip 10 and to which the vacuum gripping pad 14 and associated structure is attached is of block-like form having a vertical passage through which the shaft 6 extends. In the embodiment shown, the shaft 6 is externally threaded and the body 15 houses a split nut (not shown) having two halves which are normally engaged with the thread of the shaft. It is to be noted that the shaft 6 is threaded over substantially its entire length, although in these drawings which are only schematic drawings the thread is for clarity of illustration only indicated on part of the shaft. The body 15 carries a release system which operates under spring bias to maintain the two halves of the split nut in engagement with the thread of the shaft 6. The release system is manually actuable to move the two halves of the nut apart out of engagement with the thread, and in this disengaged position the vacuum grip 10 is able to be quickly displaced along the shaft into a selected position for use, whereon the vacuum grip 10 can be retained in that position by re-engagement of the two halves of the split nut with the thread. In the embodiment shown, release of the half nuts is effected by depressing a button 16 incorporated in a side wall of the main body 15.

The main body 15 also includes an outer handle 18 by which the vacuum grip 10 can be held for displacement along the shaft 6. Conveniently, the release button 16 is aligned with the axis of the handle 18 and is at one end thereof so that the handle 18 may be gripped with one hand with the thumb of that hand depressing the release button 16 to permit the movement of the vacuum grip 10 along the shaft 6.

The system just describes a quick-action coarse adjustment of the position of the vacuum grip 10 along the shaft 6 to suit a particular application and, for many applications, this type of adjustment will be adequate so that the trolley can readily be adjusted to suit the size of glass sheet being handled and also the height at which the glass sheet is held above the ground. However, for applications such as shop fitting when it is necessary for the grass sheet to be maneuvered into substantially precise alignment with a frame for fitting into the frame, a further, fine, adjustment system is provided. In the embodiment shown, this fine adjustment is provided by rotating the shaft 6 while the vacuum grips 10 are attached to the sheet with their split nuts engaged with the thread of the shaft 6 whereby rotation of the shaft 6 in a selected direction will cause the vacuum grips 10 associated with the shaft 6 and hence the sheet carried thereby, to move upwardly or downwardly. In the embodiment shown where two trolleys 2 are used to carry the sheet of glass it will be appreciated that by selective rotation of each of the two shafts 6 the sheet of glass can be accurately positioned at a height such that it can be “pushed” on the trolleys 2 into the support frame in exact alignment with the opening of the frame. Although the degree of adjustment which can be achieved in this way is dependent of the thread pitch, even with a relatively coarse thread a relatively fine vertical adjustment can be achieved to provide accurate placement of the glass sheet.

Rotation of the shaft 6 to effect this fine adjustment can be effected in any suitable way, for example using a handle linked to the shaft via a suitable gear system. In the particular embodiment shown, the shaft 6 is formed with a pinion gear 20 driven by reciprocating movement of a handle 22 via a reversible pawl 24 so that by appropriate setting of the pawl 24 the pinion gear 20 is driven by a ratchet action in a selected direction by operation of the handle 22, and thus the shaft 6 can be driven in a direction either to raise or lower the position of the vacuum grips 10, as required. A lever for setting the driving direction of the pawl 24 is shown at 26. It will be seen that the ratchet handle 42 projects substantially horizontally to facilitate easy access. In alternative arrangements, the shaft 6 can be rotated via a bevel-gear system using a handle located at the front of the trolley (ie the side remote from the glass) with the handle being rotatable in either direction in order to raise and lower the vacuum grips 10.

Although a fine adjustment system provided by rotation of the shaft is preferred for some applications, for applications where fine adjustment in the positioning of the sheet carried by the trolley is not required this facility could be omitted.

In a simplified and preferred embodiment, the vacuum grips 10 are slidable along the shaft 6 and each vacuum grip 10 is securable in a selected position along the shaft 6 by insertion of a pin through an aperture in the body 15 of the vacuum grip to engage in a selected one of a series of vertically spaced holes or other apertures formed in the upper and lower parts of the shaft 6. This is illustrated in FIG. 5, in which the holes in the shaft are shown at 30. It will be appreciated that the adjustment in this embodiment will thereby be in discrete steps along the shaft 6 and although it does not permit the fine degree of height adjustment enabled by the first embodiment, nevertheless for some applications this relatively coarse stepwise adjustment will be quite sufficient particularly in situations where the trolley is not used to accurately position the sheet carried by the trolley. In this embodiment the body 15 can be of simpler form than that shown in FIG. 2 as it does not need to house internal mechanism. All that is necessary is that the body provides a sliding support for the vacuum grip 10 on the shaft 6. In the specific form shown the body comprises upper and lower tubular portions or bands 15a which receive the shaft 6 and which are apertured to receive the pin for engagement in the selected hole 30.

Instead of using a pin insertable through an aperture in the body of the vacuum grip to lock the vacuum grip to the shaft in a selected position, the body may be associated with any other suitable form of locking system to lock the vacuum grip against downwards movement from its selected position on the shaft.

In the embodiment shown in FIG. 5, the shaft 6 is inclined rearwardly to the vertical and is attached to a rearwardly extending support arm 32 having a caster wheel at its lower end so that the shaft 6 is supported by two caster wheels arranged in tandem in a fore-aft direction, that is a direction transverse to the plane of the sheet. The rearwards inclination of the shaft 6 ensures that the centre of gravity of the trolley with the sheet attached thereto will lie between the wheels to provide a stable support whereby the trolley with the sheet attached thereto will not tend to tip in a fore-act direction. Tests have determined that this is to be preferred to an arrangement in which the trolley has only a single wheel as in that case the operator does need to ensure that during maneuvering the shaft of the trolley is always held substantially vertically because, otherwise, if the centre of gravity is to one side or the other of the single wheel in the fore-aft direction there is an inherent tendency for the trolley to further incline under the weight of the sheet. Accordingly, for an embodiment of the form shown in FIGS. 1 to 4, it is likewise preferred that a tandem wheel arrangement of this general type is adopted.

To facilitate extra versatility, the shaft 6 may be of two-part telescopic construction to permit easy adjustment of the effective length of the shaft. The two parts of the shaft can be held in their selected extension by a pin extending between aligned holes 30 in the two parts of the shaft.

For added safety, the shaft 6 preferably carries a support foot 36 at its lower end and which is able to carry the weight of the sheet in the event of failure of the vacuum grips to properly hold the sheet. The support foot 36 is lockable in an adjustable position in the lower part of the shaft 6.

In a variation of this embodiment to provide height adjustability for the sheet while held by the vacuum grips 10, the body of each of the grips 10 is mounted for sliding movement along the shaft. One of the two grips, preferably the lower of the two grips, is attached to a cable of a winch carried by the trolley with the winch cable passing from the grip upwardly along the shaft over a pulley at the upper end of the shaft so that operation of the winch will serve to raise or lower that grip and the sheet carried thereby upwardly or downwardly along the shaft. The other vacuum grip by virtue of its vacuum attachment to the sheet will be moved simultaneously with the first vacuum grip. This arrangement can be used not only to accurately position the sheet for placement, such as placement of a large glass sheet into a frame, but also it permits lowering of the sheet onto the ground.

In a variation of this concept, one of the two vacuum grips slidably mounted on the shaft is carried by a gas spring or similar which is also slidably mounted on the shaft by a mounting sleeve which is able to be locked in a selected position, for example by engagement of a pin into a selected one of the series of holes 30 spaced along the shaft. In this form the gas spring can be actuated to permit controlled lowering of the associated grip and the sheet carried thereby to the ground under the weight of the sheet. When the sheet has been released from the two vacuum grips, the gas spring can then be actuated to return the lower grip to a selected raised position under the force of the spring.

In modification of each of the embodiments disclosed herein, the lower end of the shaft is connected to the wheel or wheels 8 via a gas spring or similar which can be actuated to permit controlled lowering of the shaft and sheet carried thereby to the ground under the weight of the sheet. When the sheet has been released from the vacuum grips, the gas spring can then be actuated to return the shaft to a selected raised position under the force of the spring.

A trolley particularly of free form described with reference to FIG. 5 may be built for a specific usage, for example in a factory environment or similar, having sheets of predetermined size in which case it may not be necessary to incorporate a facility for adjusting the position of the vacuum grips along the shaft.

The trolley 2 of the described embodiments is specifically designed for use with at least one other trolley to jointly carry a sheet in the manner illustrated in FIG. 1 and trolleys of this form are suitable for use with a wide range of sizes of sheet. A trolley having applicability just to smaller sizes of sheet can be of similar construction to that just described but with the lower end of the shaft 6 coupled to a chassis or beam carrying two or more wheels spaced along the length direction of the sheet to provide a stable longitudinal support for the sheet when the trolley is positioned approximately midway along the length of the sheet. Advantageously, the chassis/beam also carries one or more further wheels lying rearwardly of the plane of the sheet (in the manner shown in FIG. 5) to provide stable support laterally of the sheet. Depending on the size of the trolley it may be necessary to incorporate bracing between the shaft and chassis/beam to ensure the structural integrity of the trolley.

Although the invention has been particularly described in relation to the handling of glass sheets, it is to be understood that the trolleys as described are equally applicable to handling other relatively heavy rigid sheet material such as metal sheet, marble, or plasterboard.

The embodiments have been described by way of example only and modifications are possible within the scope of the invention.

1. A device for handling glass or other sheet material, said device being in the form of a wheeled trolley and having at least one vacuum grip for releasable attachment to the surface of the sheet to thereby support the sheet from the trolley, said trolley having at least one ground-engaging wheel, and means enabling the height of the vacuum grip relative to the wheel to be adjusted.

2. A device according to claim 1, wherein the trolley comprises a support shaft which extends upright in use of the trolley, and the vacuum grip is mounted for movement along the shaft into a selected position with means to secure the grip in the selected position.

3. A device according to claim 2, wherein the shaft has a series of apertures spaced lengthwise of the shaft and the vacuum grip is secured in a selected position by engagement of a removable lock member in a selected one of the apertures.

4. A device for handling glass or other sheet material, said device being in the form of a wheeled trolley capable of manual manipulation and having a support shaft which extends upright-in use of the trolley; two or more vacuum grips mounted on the shaft for movement into selected positions along the shaft, and means for supporting at least one of the grips in a selected position along the shaft.

5. A device according to claim 4, wherein the means for supporting the said one grip position comprises means for locking the vacuum grip against movement relative to the shaft in the selected position.

6. A device according to claim 5, wherein the second vacuum grip is associated with means for positively locking that grip to the shaft in a selected position.

7. A device according to claim 4, wherein the means for supporting the said one grip is operative to permit controlled lowering of that grip relative to the shaft under the weight of the sheet carried by the grip.

8. A device according to the claim 7, wherein the means for supporting the first grip comprises a winch system carried by the trolley, a winch cable of the winch system passing downwardly relative to the shaft, the first grip being attached to a lower end portion of the winch cable such that operation of the winch is effective to raise the first grip and the sheet carried thereby, and the winch is controllable to permit lowering of the first grip and the sheet carried thereby under the weight of the sheet.

9. A device according to claim 7, wherein the means for supporting the first grip in a selected position comprises a gas spring releasable to effect controlled lowering of the first grip under the weight of the sheet carried thereby.

10. A device according to claim 7, wherein the second grip is mounted on the shaft for sliding movement along the shaft independently of the first grip, the two grips being coupled for co-joint movement when both are attached to the sheet.

11. A device for handling glass or other sheet material, said device being in the form of a wheeled trolley capable of manual manipulation and having at least one vacuum grip for releasable attachment to the surface of the sheet to thereby support the sheet from the trolley, the trolley having at least one ground-engaging wheel.

12. A device according to claim 11, wherein the trolley comprises a support shaft which extends upright in use of the trolley and the at least one vacuum grip is mounted to the shaft.

13. A device according to claim 12, wherein at least two vacuum grips are mounted to the shaft and spaced along the shaft relative to one another.

14. A device according to claim 11, wherein the at least one vacuum grip is mounted in a fixed position relative to the shaft.

15. A device according to claim 11, wherein the at least one vacuum grip is mounted in adjustable positions along the shaft.

16. A device according to claim 11, having means for supporting a lower edge of the sheet in the event of failure of the at least one vacuum grip to provide the required support.

17. A device according to claim 11, having means to permit controlled lowering to the ground of the sheet supported by the at least one vacuum grip.

18. A device according to claim 1, wherein the trolley has at least one caster wheel.

19. A device according to claim 18, wherein the trolley has two caster wheels arranged in tandem in a direction transversely to the plane of the sheet carried thereby, the configuration of the two or more wheels in the trolley being such that the weight of the sheet tamed thereby will not induce tipping of the trolley in a fore-aft direction transversely to the plane of the sheet.

20. A sheet handling system having two or more devices as claimed in claim 1, said devices being separate and being independently connected to the sheet at spaced positions along the length of the sheet.

21. (canceled)
